(19) United States
(12) Patent Application Publication
(10) Pub. No.: US 2006/0025324 A1
(43) Pub. Date: Feb. 2, 2006

(54) Method of using a defoamer

(76) Inventors: Jan H. Beetge, Pearland, TX (US); Petrus Johannes Venter, Pearland, TX (US); Robert Cleary, Ft. McMurray (CA); Jamie Kuzyk, Ft. Murray (CA); Bryon Shand, Sherwood Park (CA); D. Ann Davis, Houston, TX (US); Drew W. Matalamaki, Pearland, TX (US)

Correspondence Address: STREETS & STEELE, 13831 NORTHWEST FREEWAY, SUITE 355, HOUSTON, TX, 77040, US

(21) Appl. No.: 11/112,744

(22) Filed: Apr. 22, 2005

Related U.S. Application Data
(60) Provisional application No. 60/565,048, filed on Apr. 23, 2004.

(51) Int. Cl. C11D 17/00

(52) U.S. Cl. 510/421

(57) ABSTRACT

A method for using a defoaming formulation useful as an antifoaming agent, a foam controlling agent, or a defoaming agent. The method comprises adding the defoaming formulation that comprises one or more alkoxylate species to a system, wherein the one or more alkoxylate species is characterized as Acc-[(Ox)ᵢ]ₙ, wherein Acc is an acceptor having a functionality of n ranging between 1 and about 100. (Ox)ᵢ are oxide blocks, each oxide block having a composition comprising from 1 to 150,000 units of oxide species selected from ethylene oxide, propylene oxide, butylene oxide or combinations thereof and i ranges between 1 and about 10. The composition of adjacent oxide blocks is different and the average molecular weight of the one or more alkoxylate species is greater than about 2500 gmole⁻¹. Some embodiments of the present inventions have mixtures of alkoxylate species having average molecular weights between about 5000 and about 3,000,000 gmole⁻¹.

This patent application claims the benefit of U.S. Provisional Application 60/565,048, filed Apr. 23, 2004.

### BACKGROUND OF THE INVENTION

1. Field of the Invention

This invention generally relates to a defoamers and to methods of their use.

2. Description of the Related Art

When carrying out industrial processes for which aqueous or substantially aqueous media are used, there frequently occur troublesome foams which, for example, can retard the speed of the process, impair the quality of the process products and even damage process equipment. Unwanted fluid foams are made up of numerous tiny bubbles of a mechanical or chemical origin which are generated within a liquid and which rise and accumulate at the liquid surface faster than they decay. Typical processes which are affected by these troublesome foams are, for example, processes for manufacturing and finishing paper, processes for finishing and dyeing textiles, oil drilling and refining operations, recovery of bitumen from tar sands, and also those processes for purifying and processing effluents by mechanical, chemical or biological means, which are carried out in conventional waste water purification plants. Liquid coolants, hydraulic fluids, lubricants, aviation fuels and gas absorption systems may foam with undesirable results under conditions of operation. If not properly controlled, foam can reduce equipment capacity and increase processing time and expense, and in some instances, cause other dangers.

Although foam can be controlled in some instances by making changes to the process itself, or by using mechanical defoaming equipment, chemical antifoam formulations have proven effective and economical. To this end it is known to use antifoams, for example silicone oils, palm oil, linseed oil, lower alkyl glycols, and block copolymers of lower alkylene glycols in order to prevent foam formation or to break down foam that has formed. Such antifoams or defoamer compositions may comprise a single component or multiple components which may be combined by simply mixing together.

New defoamers are still needed to control or prevent foaming in the chemical and industrial process industry. Often the cost of controlling foam with known chemical or mechanical foaming techniques is quite high requiring, for example, adding high concentrations of a defoamer to a process. Furthermore, some common and highly effective defoamers, for example, those containing silicone, cannot be used because the components of the defoamer may act as a catalyst poison in downstream process units. Therefore, there is still a need to find additional compositions and methods for treating foaming problems that occur in the chemical and industrial process industry. It would be advantageous if the new compositions could be used in the chemical and oil processing industry without causing catalyst poisoning in downstream units.

### SUMMARY OF THE INVENTION

An embodiment of the present invention provides a method for using a defoaming formulation useful as an antifoaming agent, a foam controlling agent, or a defoaming agent. The method comprises adding the defoaming formulation that comprises one or more alkoxylate species to a system, wherein the one or more alkoxylate species is characterized as Acc-[(Ox)ᵢ]ₙ, wherein Acc is an acceptor having a functionality of n ranging between 1 and about 100. (Ox)ᵢ are oxide blocks, each oxide block having a composition comprising from 1 to 150,000 units of oxide species selected from ethylene oxide, propylene oxide, butylene oxide or combinations thereof and i ranges between 1 and about 10. The composition of adjacent oxide blocks is different and the average molecular weight of the one or more alkoxylate species is greater than about 2500 gmole⁻¹. Some embodiments of the present inventions have mixtures of alkoxylate species having average molecular weights between about 5000 and about 3,000,000 gmole⁻¹.

In certain embodiments of the present invention, the ratio of butylene oxide to propylene oxide may range between about 200:1 and about 1:200, the ratio of ethylene oxide to propylene oxide may range between about 200:1 and about 1:200 and the ratio of butylene oxide to ethylene oxide may range between about 200:1 and about 1:200.

The acceptor is a compound comprising one or more active hydrogen atoms that can be substituted in an epoxidation reaction. The acceptor may be selected from compounds having a hydroxyl group, an amine group, an ester group, a carboxyl acid group or combinations thereof. Alternatively, the acceptor may be selected from an alkyl phenol, a trimethyl propanol, a glycerol, a sorbitol, a sucrose, a polyhydroxy compound, a sugar or combinations thereof. In certain embodiments, the acceptor may be selected from an alkylphenol formaldehyde resin that is linear, branched or cyclic. The acceptor may further be selected from alkylphenol formaldehyde resins augmented by co-condensation with an amine selected from an alkyl amine, an aryl amine, a hydroxyl amine or combinations thereof.

The alkoxylate may be crosslinked with a crosslinking agent to form complex polyesters, complex branched ethers, complex branched urethanes or combinations thereof. The crosslinking agent may be selected from diepoxides, diacids, polyacids, polyacrylic acids, isocyanates or combinations thereof.

The defoaming composition may further comprise a carrier selected from water, an alcohol, a petroleum distillate or combinations thereof. The carrier in the defoaming composition may range between about 0 and about 95 wt. %. The defoamer composition may be a solution, a dispersion or an emulsion.

In a preferred embodiment, the mixture of alkoxylates is added to the system at a concentration of between about 1 wt. ppm and about 750 wt. ppm or preferably between about 25 wt. ppm and about 300 wt. ppm.

### BRIEF DESCRIPTION OF THE DRAWINGS

FIGS. 1A-B are graphs showing a comparison of the performance of an existing commercial defoamer and defoamers provided by the present invention.

FIG. 2 is a graph showing the performance of an existing commercial defoamer and the performance of a defoamer of the present invention at varying treatment concentrations.

FIG. 3 is a graph showing a comparison of the performance of an existing commercial defoamer and defoamers provided by the present invention.

### DETAILED DESCRIPTION

The present invention provides a defoamer and methods for using the defoamer in, for example, the chemical, oil and industrial process industry. The defoamer may be used as an antifoaming agent, as a foam controlling agent, or as a defoaming agent. An antifoaming agent prevents foam from forming at all in a process. A foam controlling agent controls the degree of foam formation to desired levels. A defoaming agent is sprayed on top of a foam to break the foam and knock the foam down.

The present invention provides a defoamer that is particularly useful for breaking and/or preventing foams that occur in mixtures of solids, water, and hydrocarbons. The defoamer may be used over wide range of temperatures, for example temperatures ranging between about 0° C. and about 200° C. and preferably between about 20° C. and about 100° C. Because the defoamer does not contain silicone, the defoamer is safe for use in process streams that contact catalysts used in a downstream process without having concerns about poisoning of the catalysts.

Foam is a collection of bubbles on the surface of a liquid forming a reduced density structure comprising liquid lamella supported by gas pockets wherein the gas is a proppant or the dispersed phase. The gas may be any gas dispersed in the liquid, such as, for example, carbon dioxide, nitrogen, methane, ethane and other hydrocarbon gases, such as higher molecular mass components including C₅, C₆ or C₇ alkanes, air or mixtures thereof. Foams are generated in systems that contain surfactants that reduce the surface tension of the liquid. The surfactants migrate to the gas-liquid interface at the liquid surface and also gather around the bubbles of gas that are rising through the liquid. For example, in a system containing water, the surfactants have a hydrophobic end and a hydrophilic end; the hydrophobic ends orient themselves towards the proppant gas whereas the hydrophilic ends orient themselves towards the aqueous phase, often accompanied by a reduction in the surface tension.

When vapor or gases that are generated or injected into a liquid break the surface of the liquid, without the presence of a surfactant, the bubbles burst and no foam is generated. However, with the presence of a surfactant, a double layer or lamella may be formed at the surface of the liquid that consists of two boundaries (gas-liquid-gas). It is the lamella that forms the foam. The lamella is formed by the surfactants at the gas-liquid interface effectively trapping the liquid between them. The lamella forms the foam and therefore, the destruction of the lamella dissipates or destroys the foam.

Silicone defoamers compete with the surfactants for their position at the gas-liquid interface in the lamella. By replacing the surfactants at the interface, the silicone weakens the lamella, causing the lamella to rupture and drain the captured liquid. Solvent defoamers dissolve the surfactant, removing them from the lamella and causing the lamella to weaken and rupture so that the captured liquid drains, destroying the foam.

The defoamer formulation of the present invention comprises one or more alkoxylate species characterized in the following form: Acc-[(Ox)ᵢ]ₙ. Acc is an acceptor for epoxide addition and may have a functionality n ranging between 1 and about 100. (Ox)ᵢ are oxide blocks, each oxide block having a composition comprising from 1 to 150,000 units of oxide species selected from ethylene oxide (EO), propylene oxide (PO), butylene oxide (BO) or combinations thereof. The number of oxide blocks i may range between 1 and about 10. The average molecular weight of the one or more alkoxylate species is greater than about 2500, preferably greater than about 5000 gmole⁻¹ and most preferably greater than about 30,000 gmole⁻¹. The average molecular weight in preferred embodiments is between about 2500 and about 5,000,000 gmole⁻¹, preferably between about 5000 and about 3,000,000 gmole⁻¹. Surprisingly, large molecular weight alkoxylates of the present invention are characterized as being excellent defoamers in both aqueous and non-aqueous systems.

Adjacent oxide blocks of the same branch of the acceptor have different composition. Adjacent oxide blocks differ in composition by comprising differing oxide species or differing ratios of oxide species. An oxide block having 100% EO differs in composition from oxide blocks having 100% PO or mixed oxides. An oxide block having 25% EO and 75% PO differs in composition from an oxide block having 30% EO and 70% PO. For mixed oxides, the EO: PO, EO: BO or PO: BO ratios may range from 200:1 to 1:200. In a preferred embodiment, the ratios may range from 20:1 to 1:20. In other preferred embodiments, the ratios may range from 1:10 to 10:1. The ratios may range between about 5:1 and about 1:5 in still other preferred embodiments.

The acceptor is selected from compounds having one or more active hydrogen atoms; that is, one or more hydrogen atoms that are easily substituted in a reaction. Examples of suitable acceptors include compounds having a hydroxyl group, an amine group (NH3, alkyl amines, aryl amines, ether amines, EDA, DETA, TEPA and polyethyleneimines), ester group, carboxyl acid group, alkyl phenols, trimethyl propanol, glycerol, sorbitol, sucrose, polyhydroxy compounds, simple and complex sugars and alkylphenol formaldehyde resins of the linear, branched and cyclic type including alkylphenol formaldehyde resins augmented by co-condensation with alkyl-, aryl-, hydroxyl alkyl amines. The acceptors result in a polymer typically having a functionality of between 1 to about 100, but the functionality could be as high as 150,000 in the polymeric type acceptors.

Crosslinking agents may be utilized to increase the molecular weight of the polymer through crosslinking reactions. Suitable crosslinking agents include diepoxides, diacids, polyacids, polyacrylic acids, isocyanates leading to the formation of complex polyesters, complex branched ethers and complex branched urethanes. Combinations of polyoxyalkylate polymers having different molecular architectures can be co-reacted either in sequence or as blends to produce complex crosslinked polymers involving reaction with poly-epoxides, polyacids and poly-isocyanates leading to the formation of complex polyoxyalkylate ethers, esters and urethanes.

The defoamer formulation may further comprise a carrier, such as water, methanol, isopropanol, kerosene, naphtha, or other hydrocarbon components. The concentration of the carrier in the defoamer may range from between 0 to about 95 wt. %.

The defoamer formulation can be a solution, dispersion or an emulsion, which could be a macro-emulsion, mini-emulsion or a micro-emulsion. For very high molecular weight polymers useful for the present invention, a dispersion in either a hydrocarbon or water is preferred. The formulation may further comprise one or more additional components or additives that assist or compliment the delivery and/or performance of the alkoxylates.

The following examples demonstrate the efficacy of the method of the present invention. Table 1 provides the composition of each of the tested formulations. It is recognized that the alkylene oxide monomers EO, PO and BO are polymerized to form the alkyleneoxy groups in the resulting alkoxylates. However, in disclosing the makeup of particular compounds, the accepted practice of referring to the oxides that are used to form the alkyleneoxy groups as the constituents of the polymer is followed below.

TABLE 1
Composition, %

| | Formulation | | | | | | | |
|---|---|---|---|---|---|---|---|---|
| | A | B | C | D | E | F | G | H |
| | Molecular Weight Range Low to High | | | | | | | |
| | 150,000 | 1,000 | 1,000 | 1,000 | 100,000 | 2400 | 2800 | 300,000 |
| | 1,500,000 | 10,000 | 10,000 | 10,000 | 1,000,000 | 2600 | 3000 | 3,000,000 |
| BS04-42 | 66.7 | 33.3 | | | | | | |
| BS04-46 | 50 | | 50 | | | | | |
| BS04-47 | 66.7 | | | 33.3 | | | | |
| BS04-49 | | 33.3 | | | 66.7 | | | |
| DWM 2-36-9 | | | | | | 100 | | |
| DWM 2-36-11 | | | | | | | 100 | |
| 2004-72 | | 25 | | | | | | 75 |

Component A is available from Champion Technologies, Inc., having an office in Fresno, Tex., as Product 468. This material is a high molecular mass branched polypropoxylate. The molecular weight of this material is between about 150,000 to about 1,500,000 gmole⁻¹. The polymer is formed of a high molecular mass linear polypropoxylate to which between about 50 and about 60 wt. % of propylene oxide has been added to form the branched polymer.

Component B is available from Champion Technologies, Inc., as Product 743. This material is an alkyl phenol resin based random polyalkoxylate, wherein the alkyl is a mixture of butyl and nonyl alkyl groups. This polymer has a molecular weight between about 1000 to about 10,000 gmole⁻¹, having about 30% mixed oxides randomly situated on the polymer. The mixed oxides are ethylene oxide and propylene oxide having an EO:PO ratio of about 2:1.

Components C and D are available from Champion Technologies, Inc., as Product 735 and 748 respectfully. These compositions are based upon the same alkyl phenol resin of Component B, but instead of mixed oxides, Product 735 includes 23% EO and Product 748 contains 25% EO.

Component E is an intermediate complex polyol derived from the reaction of a linear polypropoxylate reacted with aromatic bis-epoxides used in the production of Component A. This linear polymer chain has a molecular weight ranging between about 100,000 and about 1,000,000 gmole⁻¹. This composition is available from Champion Technologies, Inc, as Product 447.

Compositions F and G are both linear polypropylene oxide, mixed oxide block copolymers having molecular weights of about 2400 and 2800 gmole⁻¹, respectfully. Composition F includes an EO content of about 17 mass % with an EO:PO ratio of 2:1. Composition G includes an EO content of about 10 mass % with an EO:PO ratio of 2:1. Both of these compositions are available from Champions Technologies, Inc.

Component H is available from Champion Technologies, Inc., as Product 733. This material is a derivative of Component A, described above. Component H is a complex EO/PO co-polymer formed of a high molecular mass linear polypropoxylate to which between about 50 and about 60 wt. % of propylene oxide has been added, with the subsequent addition of a mixed oxide cap. This high molecular mass block co-polymer contains a PO block of between about 45 wt. % to about 55 wt. % and a mixed oxide cap of between 45 wt. % to 55 wt. %. The mixed oxide block is a random co-polymer in itself, containing ethylene oxide and propylene oxide at an EO:PO ratio of about 1:2. The molecular weight of this material is between about 300,000 to about 3,000,000 gmole⁻¹.

### EXAMPLE 1

Defoaming tests were conducted using various formulations of the present invention. A stock material was tested that comprised about 10% bitumen and about 17% mineral solids as found in tar sands, about 51% water and about 22% solvent. The solvent was a light petroleum aliphatic naphtha. Approximately 100 mL of the stock at 75° C. was placed in a 1000 mL graduated cylinder that was maintained at about 75° C. by a hot water bath. A sparger tube with a gas sparging stone attached was placed in the graduated cylinder, which brought the level in the graduated cylinder up to the 100 mL mark.

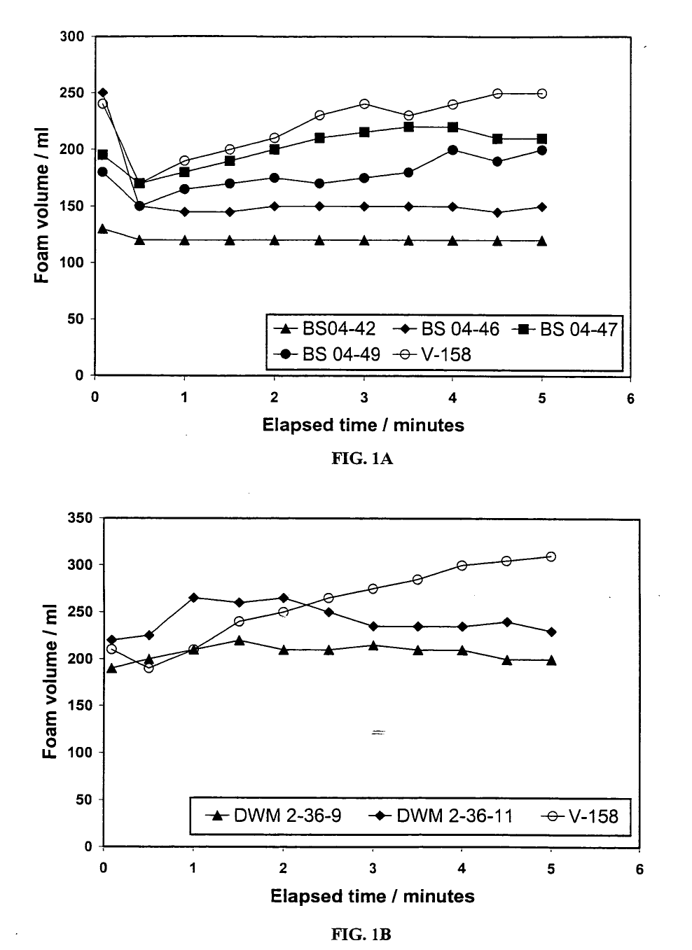

Gas flow was started through the sparging stone at a rate of about 200 mL/min. After the foam reached the 400 mL mark on the graduated cylinder, a defoamer was added from the top of the graduated cylinder and dropped into the foaming material. Foam height in the graduated cylinder was then recorded every 30 seconds over a 5 minute period. The defoamer used in this example, BS04-42 as described above, was added to the foaming stock at a concentration of 200 ppm. The results are shown in FIG. 1A, compared with a commercial defoamer V-158 manufactured by Champion Technologies, Inc. V-158 is a polyol defoamer having a molecular weight of about 2000. It should be noted that a synergistic effect may be achieved in some applications by blending a higher molecular weight material with a lower molecular weight material, such as in the BS04-42 formulation. In some applications, blending up to 50% of an alkoxylate having a molecular weight less than about 10,000 may be blended with an alkoxylate having a molecular weight greater than about 30,000 gmole⁻¹ or in another preferred embodiment, greater than about 300,000 gmole⁻¹.

### EXAMPLE 2

Using the same defoaming test procedure as described in Example 1, the defoamer BS04-46 as described above was added to the foaming stock at a concentration of 200 ppm. The results are shown in FIG. 1A, compared with a commercial defoamer V-158.

### EXAMPLE 3

Using the same defoaming test procedure as described in Example 1, the defoamer BS04-47 as described above was added to the foaming stock at a concentration of 200 ppm. The results are shown in FIG. 1A, compared with a commercial defoamer V-158.

### EXAMPLE 4

Using the same defoaming test procedure as described in Example 1, the defoamer BS04-49 as described above was added to the foaming stock at a concentration of 200 ppm. The results are shown in FIG. 1A, compared with a commercial defoamer V-158.

### EXAMPLE 5

Using the same defoaming test procedure as described in Example 1, the defoamer DWM 2-36-9 as described above was added to the foaming stock at a concentration of 200 ppm. The results are shown in FIG. 1B, compared with a commercial defoamer V-158.

### EXAMPLE 6

Using the same defoaming test procedure as described in Example 1, the defoamer DWM 2-36-11 as described above was added to the foaming stock at a concentration of 200 ppm. The results are shown in FIG. 1B, compared with a commercial defoamer V-158.

### EXAMPLE 7

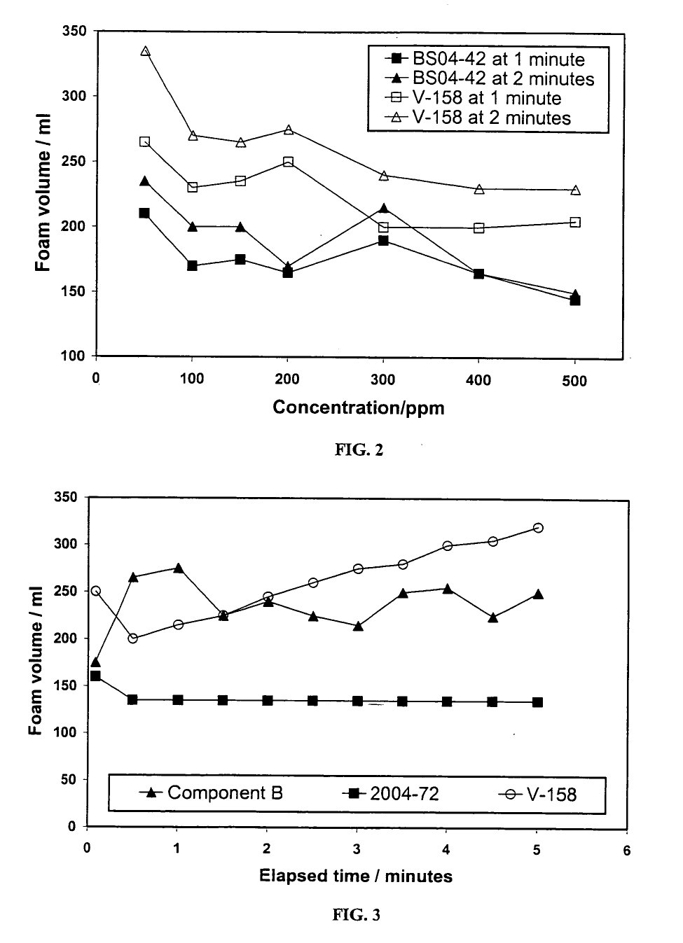

Using the same defoaming test procedure as described in Example 1, the defoamer BS04-42 as described above was added to the foaming stock at varying concentrations. Foam height readings were taken at the time of 1 minute and 2 minutes after the defoamer was added to the foaming stock. The same procedure was performed using a commercial defoamer V-158. The results are shown in FIG. 2, compared with the commercial defoamer V-158.

### EXAMPLE 8

Using the same defoaming test procedure as described in Example 1, the defoamer 2004-72 as described above was added to the foaming stock at a concentration of 200 ppm. The results are shown in FIG. 3, compared with Component B as an individual component, as well as a commercial defoamer V-158.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. For example, the phrase “a solution comprising a phosphorus-containing compound” should be read to describe a solution having one or more phosphorus-containing compound. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention.

It will be understood from the foregoing description that various modifications and changes may be made in the preferred embodiment of the present invention without departing from the invention. It is intended that this description is for purposes of illustration only and should not be construed in a limiting sense. The scope of this invention should be limited only by the language of the following claims.

What is claimed is:

1. A method, comprising:
adding a defoaming formulation comprising one or more alkoxylate species to an aqueous system, wherein the one or more alkoxylate species is characterized as Acc-[(Ox)ᵢ]ₙ, wherein Acc is an acceptor having a functionality of n ranging between 1 and about 100, wherein (Ox)ᵢ are oxide blocks, each oxide block having a composition comprising from 1 to 150,000 units of oxide species selected from ethylene oxide, propylene oxide, butylene oxide or combinations thereof, wherein the composition of adjacent oxide blocks is different, wherein i ranges between 1 and about 10, and wherein the average molecular weight of the one or more alkoxylate species is greater than about 2500 gmole⁻¹.

2. The method of claim 1, wherein the ratio of butylene oxide to propylene oxide is between about 200:1 and about 1:200.

3. The method of claim 1, wherein the ratio of ethylene oxide to propylene oxide is between about 200:1 and about 1:200.

4. The method of claim 1, wherein the ratio of butylene oxide to ethylene oxide is between about 200:1 and about 1:200.

5. The method of claim 1, wherein the mixture of alkoxylates has an average molecular weight between about 5000 and about 3,000,000 gmole⁻¹.

6. The method of claim 1, wherein the acceptor is a compound comprising one or more active hydrogen atoms that can be substituted in an epoxidation reaction.

7. The method of claim 6, wherein the acceptor is a compound having a hydroxyl group, an amine group, an ester group, a carboxyl acid group or combinations thereof.

8. The method of claim 6, wherein the acceptor is selected from an alkyl phenol, a trimethyl propanol, a glycerol, a sorbitol, a sucrose, a polyhydroxy compound, a sugar or combinations thereof.

9. The method of claim 6, wherein the acceptor is selected from an alkylphenol formaldehyde resin that is linear, branched or cyclic.

10. The method of claim 9, wherein the acceptor is selected from alkylphenol formaldehyde resins augmented by co-condensation with an amine selected from an alkyl amine, an aryl amine, a hydroxyl amine or combinations thereof.

11. The method of claim 1, wherein the alkoxylate is crosslinked with a crosslinking agent to form complex polyesters, complex branched ethers, complex branched urethanes or combinations thereof.

12. The method of claim 11, wherein the crosslinking agent is selected from diepoxides, diacids, polyacids, polyacrylic acids, isocyanates or combinations thereof.

13. The method of claim 1, wherein the defoaming composition further comprises a carrier selected from water, an alcohol, a petroleum distillate or combinations thereof.

14. The method of claim 13, wherein the carrier in the defoaming composition ranges between about 0 and about 95 wt. %.

15. The method of claim 13, wherein the defoamer composition is a solution, a dispersion or an emulsion.

16. The method of claim 1, wherein the mixture of alkoxylates is added to the aqueous system at a concentration of between about 1 wt. ppm and about 750 wt. ppm.

17. The method of claim 1, wherein the mixture of alkoxylates is added to the aqueous system at a concentration of between about 25 wt. ppm and about 300 wt. ppm.
